(19) United States
(12) Patent Application Publication
(10) Pub. No.: US 2024/0311917 A1
(43) Pub. Date: Sep. 19, 2024

(54) NUMISMATIST SYSTEM

(71) Applicant: U.S. MONEY RESERVE (USMR), Austin, TX (US)

(72) Inventors: Angela ROBERTS, Austin, TX (US); Michael Jerome KOCH, Leander, TX (US); Michael GOODMAN, Austin, TX (US)

(73) Assignee: U.S. MONEY RESERVE (USMR), Austin, TX (US)

(21) Appl. No.: 18/575,508

(22) PCT Filed: Apr. 13, 2022
(86) PCT No.: PCT/US2022/024648

§ 371 Date: Dec. 29, 2023

Related U.S. Application Data
(60) Provisional application No. 63/217,428, filed on Jul. 1, 2021.

(51) Int. Cl. G06Q 40/06

(52) U.S. Cl. CPC G06Q 40/06

(57) ABSTRACT

An automated precious metal portfolio selection system and method that promotes a self-assessment of risk tolerance which can be completed by an investor or third-party salesperson to input the same in an evaluation protocol which sets forth a level of risk tolerance, and the generation of a portfolio of precious metals items. Through an application of standardized protocol, the salesperson need not have experience of a numismatist or precious metals expert. The automated system and method provide a confirmation of the final calculation of the cost of the precious metal items as of the closing of a financial transaction. The precious metal items are transferred along with a suitable inventory for the various types and/or denominations of the precious metal items, and a depository account is created. The system and method can also facilitate reporting the then current value and any obligation to necessary parties, such as for an IRA.

### CROSS REFERENCE TO RELATED APPLICATIONS

This application claims priority to U.S. provisional application Ser. No. 63/217,428 filed on Jul. 1, 2021, the content of which is incorporated by reference herein in its entirety.

### FIELD OF THE INVENTION

The present invention relates to a system and method for automating the selection of portfolio items, in particular for precious metal portfolio items.

### DESCRIPTION OF RELATED ART

Despite significant interest by many in applying precious metals as part of investment portfolios, there have been serious restrictions to many. A readily available, user-friendly capability does not exist for most investors.

Part of the restriction is due to the lack of knowledge by many in selecting precious metals, and determining what an appropriate investment amount would be. That uncertainty exists both with regard to the investor as well as the individuals representing the entity selling the precious metals such as precious bullion and/or coins. There is a little background and training, other than as a subspecialty to a very limited number of individuals.

Even if an appropriate amount of investment can be ascertained, the selection of specific coins that can be used for purposes of investing continually changes, as does the daily market value of precious metal coins. There are a few trained persons able to have immediate access to the appropriate inventory and valuation of precious metal item such as coins, bullion or bars, which could be available for use and purchased in quantities and amounts to satisfy an appropriate and reasonable investment decision. Moreover, there are limited entities from which precious metal items can be purchased with agreed values on any given day or even an hour, and the items selected need to be available for transfer to a reliable trustee or depository, as many who wish to use coins as an investment are uncomfortable with accepting actual delivery of the precious metal items. In addition, some investors are also uncomfortable with having their precious metal items placed in depository that they do not have full confidence in.

As a result, there are only limited numbers of entities that can effectively advise in the selection and purchase of precious metal items including coins for purposes of investment, in particular for investment vehicles such as an Investment Retirement Account (IRA) that is regulated by 26 USC § 408 or other retirement accounts. These specialty entities have expertise and technical capabilities in all of the documentation and reporting for tax purposes necessary to maintain a precious metal IRA, as well as the limited number of precious metal items which are recognized as qualified investments.

### SUMMARY

The present invention provides a system and method which permits a self-assessment of risk tolerance by the client in an evaluation protocol as a subjective variable. The evaluation protocol further assigns an objective assessment of risk tolerance, which taken with the self-assessment provides a basis for the portfolio selection. The evaluation protocol utilizes a combined risk assessment and other variables provided by the client including the type of metal and the amount of the investment, and updated pricing and inventory information, to generate a metal portfolio information set of precious metal coins and/or bullion and/or bars (also referred to herein as “precious metal items”).

In an embodiment, an automated precious metal portfolio selection method comprises: providing a computer comprising a non-volatile memory device that stores program modules and data, and a processor coupled to the memory; entering into the computer data comprising: a precious metal item inventory/information table including, for a plurality of precious metal items that are each identified by an identifier or item number, a value in currency units, and an indication of availability or number of units available; a precious metal item percent table including sets of variables, the variables comprising an investment amount range in currency units, a risk tier, and an indication of the types of precious metal, and for each unique set of variables, a plurality of precious metal items identified by an identifier or item number as a first precious metal item and subsequent precious metal item(s), and a first allocated percentage of the first precious metal item and subsequent allocated percentage of the subsequent precious metal item(s), wherein the identifier or item number for each precious metal item in the precious metal item percent table correlates with the identifier or item number used in the precious metal item inventory/information table; client information for each of a plurality of clients including at least demographic information, a subjective self-assessed risk assessment indicator, an investment amount, and an indicator of one or more types of metals; calculating, by the processor, an objective risk assessment indicator for each client based upon on demographic information, and a combined risk assessment indicator for each client based on the subjective self-assessed risk assessment indicator and the objective risk assessment indicator, wherein the combined risk assessment indicator is correlated to the risk tier in the precious metal item percent table; selecting, by the processor, the first and subsequent precious metal item(s) and the first and subsequent allocated percentages, from the precious metal item percent table, based on the set of variables for a given client including the combined risk tolerance that is correlated with the risk tier in the precious metal item percent table, the investment amount that is correlated with the investment amount range in currency units in the precious metal item percent table, and the indicator of one or more types of metals that is correlated with the indication of the types of precious metal in the precious metal item percent table; calculating, by the processor, the amount in currency units of the first and subsequent allocated percentage as first and subsequent allocated amount(s); and calculating, by the processor, a number of whole units of the first precious metal item in the first allocated amount and a number of whole units of the subsequent metal item in the subsequent allocated amount(s), based on the value in the precious metal item inventory/information table.

In one aspect, data entered into the computer further comprises a supplemental items list including one or more first supplemental precious metal items and one or more subsequent supplemental precious metal items, that are associated with one or more of the first precious metal item and the subsequent precious metal item(s) in the precious metal item percent table and with one or more precious metal items in the precious metal item inventory/information table, the method further comprising: calculating, by the processor, a first remainder of the first allocated amount and subsequent remainders of the subsequent allocated amount(s); and calculating, by the processor, a number of whole units of the first supplemental precious metal item of the first remainder and a number of whole units of the supplemental precious metal item(s) of subsequent remainder(s), based on the value in the precious metal item inventory/information table.

In another aspect, the step calculating, by the processor, the number of whole units of the first precious metal item in the first allocated amount and the number of whole units of the subsequent metal item in the subsequent allocated amount(s), is carried out in a first instance and in a second instance, wherein the first instance corresponds to a time associated with an order by a client and wherein the second instance corresponds to a time of purchase by a client, wherein the value in the precious metal item inventory/information table of one or more of the first precious metal item or the subsequent metal item differs in the first instance and in the second instance.

### BRIEF DESCRIPTION OF THE DRAWINGS

The invention will be described in further detail below and with reference to the attached drawings in which the same or similar elements are referred to by the same number, and where:

FIG. 1 is a block diagram of exemplary architecture for an automated precious metal portfolio selection system of the present invention;

FIG. 2 is a process flow chart showing an overview of the automated precious metal portfolio selection method of the present invention,

FIG. 3 is an example of a client intake form including data used as variables in the automated precious metal portfolio selection system and method of the present invention;

FIG. 4 is an example of a selected portfolio information set generated by the automated precious metal portfolio selection system and method of the present invention;

FIG. 5 is an example of product details for precious metal items in a selected portfolio information set;

FIG. 6 is a portion of a precious metal item inventory/information table that is used in the automated precious metal portfolio selection system and method of the present invention;

FIGS. 7A, 7B and 7C are portions of a precious metal item percent table that is used in the automated precious metal portfolio selection system and method of the present invention;

FIG. 8 is a portion of a supplemental item table that is used in certain embodiments of the automated precious metal portfolio selection system and method of the present invention;

FIGS. 9A and 9B is a process flow chart showing steps to determine the selected portfolio information set, including identification of main precious metal items and quantities and supplemental precious metal items and quantities, in the automated precious metal portfolio selection system and method of the present invention; and

FIG. 10 is a diagrammatic representation of a computer that can be used as a computing device and/or as a server computer in the system and method herein.

### DETAILED DESCRIPTION

According to the present invention an automated precious metal portfolio selection system and method are provided which promotes a self-assessment of risk tolerance which can be completed by the investor or relayed to the third-party salesperson to input the same in an evaluation protocol which sets forth a level of risk tolerance, and the generation of a portfolio of precious metals items. Through the application of standardized protocols described herein, the salesperson need not have experience of a numismatist or precious metals expert. In addition, the automated precious metal portfolio selection system and method provides a confirmation of the final calculation of the cost of the precious metal items as of the closing of a financial transaction. The precious metal items are transferred along with a suitable inventory for the various types and/or denominations of the precious metal items, and a depository account is created. In certain embodiments the automated precious metal portfolio selection system and method also facilitates reporting the then current value and any obligation to necessary parties, such as is mandatory with an IRA.

Unlike many financial assets that can be fractionally divided, precious metal items are purchased in whole integers at a unit cost per item. As is described in more detail herein, the process of balancing a metal portfolio information set entails the allocation of various percentages of two or more different types of items to build the overall portfolio. For instance, consider a simplified singular example of a $10,000 portfolio. With this variable, along with the risk variable (subjective and objective) and the metal type variable described herein, the portfolio can be defined in the precious metal item percent table as having four types of precious metal items: A (40%), B (20%), C (20%) and D (20%). If the cost of item A at the time of the transaction is $625, the client's portfolio would not contain 6.4 units of item A ($625×6.4=$4000=40%×$10,000). However, a fractional purchase is not possible. In the system and method herein, only 6 units of item A are added to the portfolio. In order to minimize or eliminate any remainder of the funds for that allocation in cash, the remaining funds (that is, $250) are allocated to one or more supplemental items, selected from a constantly updated inventory of smaller valued items and their pricing. The process of selecting the precious metal items continues for each of B, C, and D. As a result, a real time precious metals portfolio is created close to the desired investment amount.

When a large number of clients are seeking this information, it is impractical and costly for a qualified expert such as a numismatist to consult individually with each client or achieve the desired portfolio efficiently. The automated process flow modules and steps of the present invention contain instructions to automate this process and provide such expertise to a multitude of clients at a fraction of the cost and in a timelier fashion.

### System Architecture

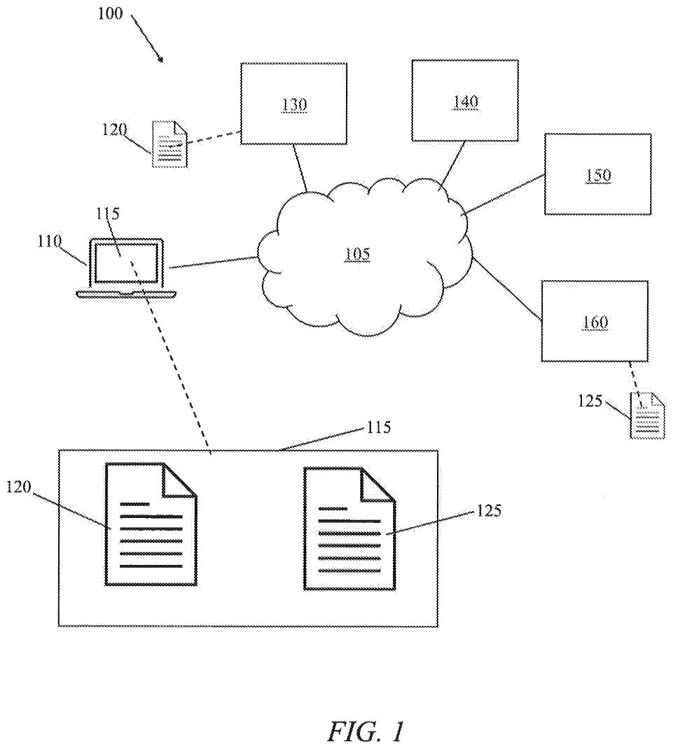

FIG. 1 is a block diagram of exemplary system architecture for a portfolio selection system 100. The system 100 operates over one or more computer network 105 that operably connects a computing device 110 (for example, a desktop computer, laptop computer, tablet computer, smartphone, etc.) that is operable to provide to a user via a user display 115 at least an on-screen client intake form 120 and a precious metal portfolio information set 125, a client information module 130, a precious metal item module 140 (a precious metal item inventory/information table), a precious metal item percent module 150 (precious metal item percent table) and a precious metal portfolio generation module 160.

Although in the embodiment shown in FIG. 1, the computing device 110, the client information module 130, the precious metal item module 140, the precious metal item percent module 150 and the precious metal portfolio generation module 160 are shown as separate entities, it should be understood that in other embodiments, one or more of these modules and/or computing devices may be stored and operated from a single server, a plurality of servers, one or more cloud-based servers, or any other suitable configuration. It should be further understood that although a label or name is given to any device or module herein the nomenclature should not be understood to limit the functionality that such server may provide to the system and method. The client information module 130, the precious metal item module 140, the precious metal item percent module 150 and the precious metal portfolio generation module 160 are operated and maintained by an entity that generates the portfolios such as a metal distributer, retail seller, an agent of the metal seller, a broker or the like (referred to herein as the “portfolio-generating entity”). In certain embodiments the portfolio-generating entity is a custodian or firm, or agent thereof, that has the expertise and technical capabilities in all of the documentation and reporting for tax purposes necessary to maintain a precious metal IRA.

The one or more computer networks 105 may include any of a variety of types of wired or wireless computer networks such as the Internet, a private intranet, a public switch telephone network (PSTN), or any other type of network. The communication link between the computing device 110, the client information module 130, the precious metal item module 140, the precious metal item percent module 150 and the precious metal portfolio generation module 160 can be, for instance, implemented via a Local Area Network (LAN) or via the Internet.

### Process Flow

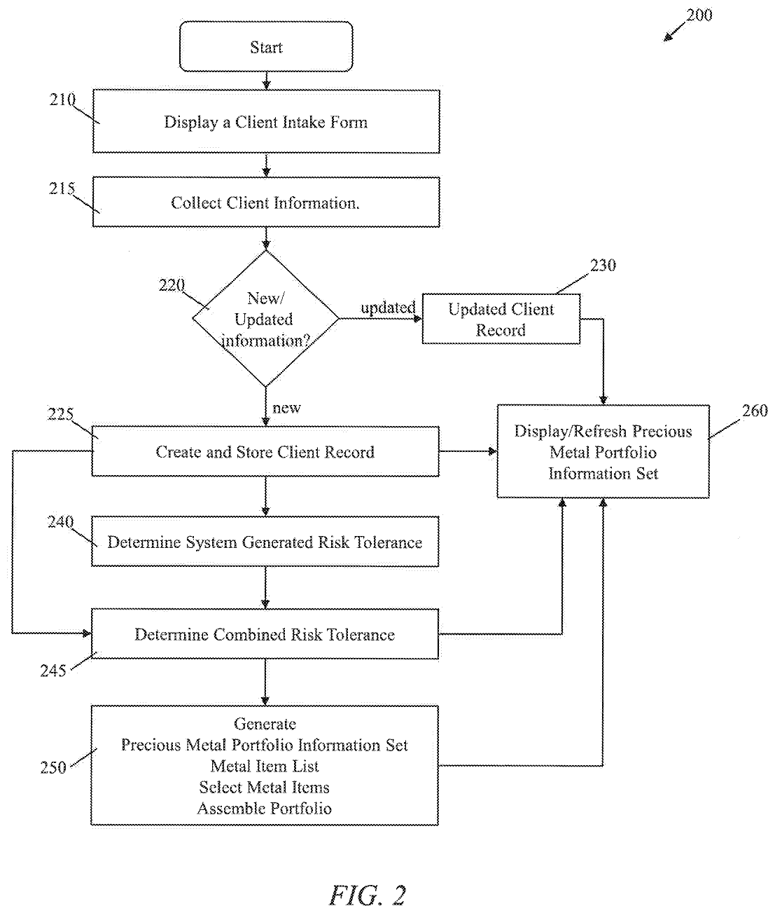

Referring to FIG. 2, steps of a process flow for carrying out automated precious metal portfolio selection are described, that can be the framework for instructions which execute on the computer(s) or other programmable data processing apparatus as all or a portion of one or more modules for implementing the functions specified in the flowchart block or blocks. In general, a process 200 is provided that enables the portfolio-generating entity to: collect and store client information (210, 215, 220, 225, 230); use demographic information, client's self-assessed risk tolerance, investment amount, and selected metal type, from the client information, to generate a precious metal portfolio information set of financial products (240, 245, 250); and provide the portfolio information set contents and details, for example which are displayed on-screen, to present the types, quantity, value, and other information about the selected precious metal items in the automated precious metal portfolio selection system and method herein (260).

At step 210, the automated process flow modules and steps contain instructions to display intake information (for example, represented as the client intake form 120) to a user on-screen (for example, the display 115 of the computing device 110). In certain embodiments, the user is a representative of the portfolio-generating entity, who can be in real time communication with a client, or using the client intake data based on previously provided information. In other embodiments, the user can be the client or another representative of the client. At step 215, the automated process flow modules and steps contain instructions to enable collection of personal and financial information from the client directly or via a representative of the portfolio-generating entity.

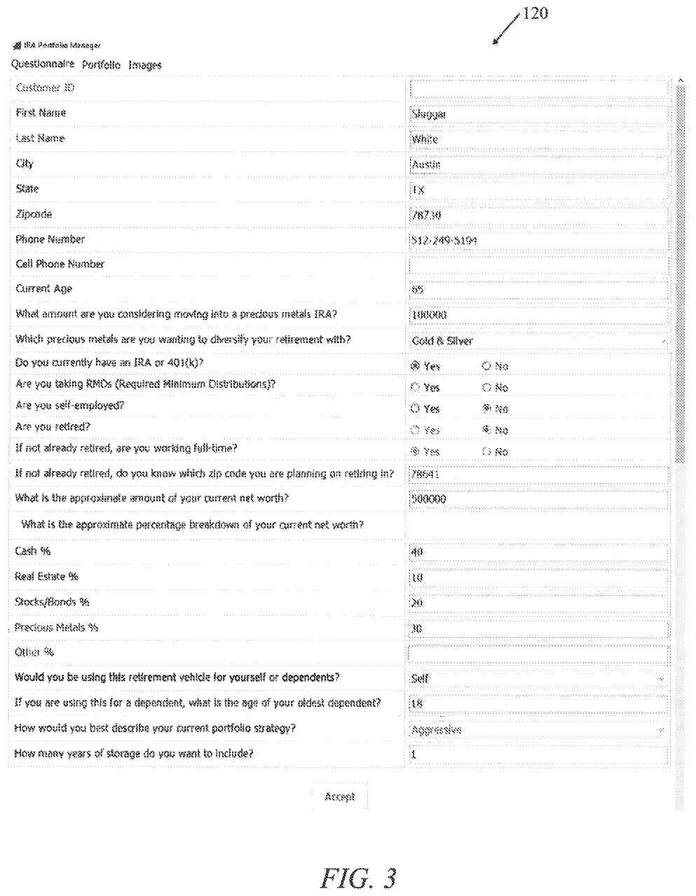

Individual questions can be configured as optional or required. Question, answers, and the schema that control their behavior can be derived, for example, from one or more databases included in the client information module 130 to facilitate modification and updates. FIG. 3 is an example of a client intake form 120 that can be used, for instance, to provide the precious metal portfolio information set and other details necessary to set up a retirement vehicle for a client. In the example client intake form 120 in FIG. 3, the fields include:
A. a client ID (internal to the portfolio-generating entity);
B. the client's name (as typical shown as first and last name, although it can also include fields for a middle name and/or title);
C. the client's address (shown as city, state and zip code, although it can also include fields for street address, apartment number, alternative addresses, email addresses, etc.);
D. the client's phone numbers (shown as home and cell, although it can also include fields for a work and/or other number);
E. the client's age (shown as years, but can be substituted or supplemented by data of birth to provide more precise and/or automatically updated age value);
F. precious metals investment amount in currency units such as dollars;
G. selection of precious metals (typically gold, silver, or a combination of gold and silver, but can also include platinum and/or palladium, individually or in combination with other precious metals);
H. whether the client has a 401(k) account or an individual retirement account (IRA);
I. whether the client is currently taking required minimum distributions on a 401(k) account or on an IRA;
J. whether the client is self-employed;
K. whether the client is retired;
L. whether the client is working full-time;
M. where the client (by zip code) intends to retire to;
N. approximate net worth of the client;
O. breakdown of net worth of the client, by cash, real estate, stocks/bonds, precious metals, and other;
P. whether the current retirement vehicle is for the client or dependent(s);
Q. age of oldest dependent if the current retirement vehicle is for dependent(s);
R. the client's subjective self-assessed risk tolerance; and
S. number of prepaid years of storage of the precious metal items.

In the automated precious metal portfolio selection system and method described herein, only certain of the above fields are described and utilized in the automated precious metal portfolio selection system and method of the present invention, including the client's age (E), the precious metal investment amount in currency units (F), the client's selection of precious metals (G) and the client's subjective self-assessed risk tolerance (R). The others can be optional, or used in other modules not described herein by the portfolio-generating entity, for instance, for portfolio reporting information to the client and to the Internal Revenue Service as is necessary. In certain embodiments, if the subjective self-assessed client risk tolerance is not provided by the client, the variable can default to the medium level risk tolerance.

At step 220, the automated process flow modules and steps contain instructions to determine whether the information provided in the client intake form is newly inputted information, or updated information. In the context of this decision, updated information can include information that replaces previously entered information, or information presented for the first time for one or more optional questions or for one or more questions that may have been skipped in the first instance of collecting information at step 215. If the decision at step 220 is that new information is being entered in the first instance of collecting information at step 215, at step 225 the automated process flow modules and steps contain instructions to create and store a new client record in the client information module 130 that includes the relevant data from the client intake form 120. If the decision at step 220 is that updated information is being entered in the first instance of collecting information at step 215, at step 230 the automated process flow modules and steps contain instructions to update and stream the associated existing client record in the client information module 130.

At step 240, the automated process flow modules and steps contain instructions to calculate or determine a system generated risk tolerance. This can be accomplished with a formula that includes as variables demographic and/or financial information from the client. In certain embodiments, an objective system generated risk tolerance is determined based on age of the client. The subjective self-assessed client risk tolerance is categorized during client information intake as a selection of two or available more categories, for example, three available categories for selection as “Conservative/Moderate/Aggressive.” At step 245, the automated process flow modules and steps contain instructions to calculate or determine a combined risk tolerance of the client based on variables including the subjective self-assessed client risk tolerance obtained at step 215 and the objective system generated risk tolerance determined at step 240; the automated process flow modules and steps contain instructions to update the client information module 130 with the combined risk tolerance of the client. The combined risk tolerance determined at step 245 can be determined as two or more categories, in certain embodiments at least one category more than the number of available categories in the questionnaire, for example five categories as “Conservative/Moderate-Conservative/Moderate/Moderate-Aggressive/Aggressive.” In other embodiments, several tiers are provided as variables for use in the automated process flow modules and steps herein, as shown in Table 1 below.

TABLE 1

| System Generated | Self-Assessed | | |
|---|---|---|---|
| Risk Tolerance | Risk Tolerance | Combined Risk Tolerance | Tier |
| Aggressive | Aggressive | Aggressive-Aggressive | 3 |
| Aggressive | Moderate | Aggressive-Moderate | 2.5 |
| Aggressive | Conservative | Aggressive-Conservative | 2 |
| Moderate | Aggressive | Moderate-Aggressive | 2.5 |
| Moderate | Moderate | Moderate-Moderate | 2 |
| Moderate | Conservative | Moderate-Conservative | 1.5 |
| Conservative | Aggressive | Conservative-Aggressive | 2 |
| Conservative | Moderate | Conservative-Moderate | 1.5 |
| Conservative | Conservative | Conservative-Conservative | 1 |

At step 250, the precious metal portfolio information set 125 is generated based on instructions contained in the automated process flow modules and steps. In certain embodiments this information is provided on a user display, via a physical medium such as printed or braille, by audible output or by another suitable format. In particular, the automated process flow modules and steps contain instructions to determine an allocated item list for the precious metal portfolio information set 125. This allocated item list is obtained using at least three variables: the combined risk tolerance that weighs both subjective and objective risk tolerance assessments; the asset type selection, for example, one or more precious metal item types selected from gold metal items, silver metal items or a combination of gold metal items and silver metal items, and in certain embodiments one or more of platinum or palladium in combination with gold and/or silver; and the investment amount. In certain embodiments, the number of storage years can also be a variable, whereby the automated process flow modules and steps contain instructions to deduct from a gross investment the total storage cost based on the number of storage years to produce a net investment amount. In other embodiments, separate from the automated process flow modules and steps, the cost of the number of storage years is deducted from the gross investment amount to provide the net investment amount as the variable. In further embodiments, the number of storage years is not a variable, and annual storage fees are handled separately, and the gross investment amount is used.

The automated process flow modules and steps contain instructions to select items from a precious metal item percent module 150 based on the variables. Other pertinent information about the individual precious metal items is also obtained from the precious metal item inventory/information table via the precious metal item module 140. The precious metal item percent module accesses a precious metal item percent table to determine allocation percentage limits for each item. If an item is not available, the precious metal item percent table can contain an alternate item to fit in that allocated amount. For instance, in the simplified example above, instead of item A, an item A1 could be identified on the precious metal item percent table as an alternate to item A. Subsequent alternates can also be provided for item A1, such as an item A2, and so on. Similarly, alternate items can be provided for items B, C and D, and the like as described herein.

A list of items is returned, designated as allocated items. In addition, the list includes the allocation percentage limits of each allocated items relative to the investment amount. During the process of generating this list, the automated process flow modules and steps contain instructions to query the precious metal item inventory/information table to ascertain availability. When a list of allocated items is obtained, the automated process flow modules and steps contain instructions to query the precious metal item inventory/information table to ascertain associated prices. The automated process flow modules and steps contain instructions to calculate the number of units of each precious metal item to assemble the portfolio. Units of allocated item quantities are increased until the allocation percentage limit of that item has been reached. If increasing the quantity of an item exceeds the percentage limit, the quantity will be fixed at the previous quantity. Once this quantity is fixed, the actual percentage filled is subtracted from the item percentage limit.

Any excess value within an allocation percentage can be filled with supplemental items. Each item can be mapped to one or more supplemental items. Filling of supplemental items is in the same manner as other listed items, other than the allocation percentage limit. These supplemental items are designated only to fill a percentage remainder from an original allocated item. When all allocated items have been iterated through, and each allocated item percentage limit has been filled as much as possible including supplemental items, the process is reiterated in reverse order to fill any remainder, while ignoring the item allocation percentage limits, and only considering the total remainder.

Supplemental items are typically items that are more closely related to the primary item than others. For example, item A can be characterized by its liquidity, scarcity premium, price appreciation potential, or other factors. It is categorized, for example, using the expertise of a numismatist. One or more supplemental items are selected that have similar characteristics to the primary item to fill any remainder. For instance, in certain embodiments, one or more supplemental items used to fill any remainder when item A is the primary item are selected so as to be in the same item family or series. For example, if the primary item is “$25 American Eagle Proof Gold” coin that contains 0.5 ounces of gold, then suitable supplemental items can be “$10 American Eagle Proof Gold” that contains 0.25 ounces of gold, and/or “$5 American Eagle Proof Gold” that contains 0.1 ounces of gold. In this particular case the precious metal items are coins are in the same series, with different denominations and gold weights.

At step 260, the automated process flow modules and steps contain instructions to display or refresh the portfolio information set when a threshold level of information is collected and stored, via the display 115. This step can occur in parallel with the creation of client records at step 225, the updating of client records at step 230, with the determination of the combined risk tolerance level at step 245, and with the generated portfolio information set at step 250.

When the portfolio information set is displayed after step 250, details for the portfolio are provided in the precious metal portfolio information set 125, including one or more of the variables (the combined risk tolerance, the asset type selection, the investment amount, and the number of storage years), and the generated information including the number of items of each type, remainders and percentages fulfilled (both within each item type and an overall percentage fulfilled). In addition, details for each item are shown, including the item name, percentage within the portfolio, quantity, price and extended price. Images and detailed marketing description for each item can also be provided in the precious metal portfolio information set 125, or provided by a suitable internal or external hyperlink.

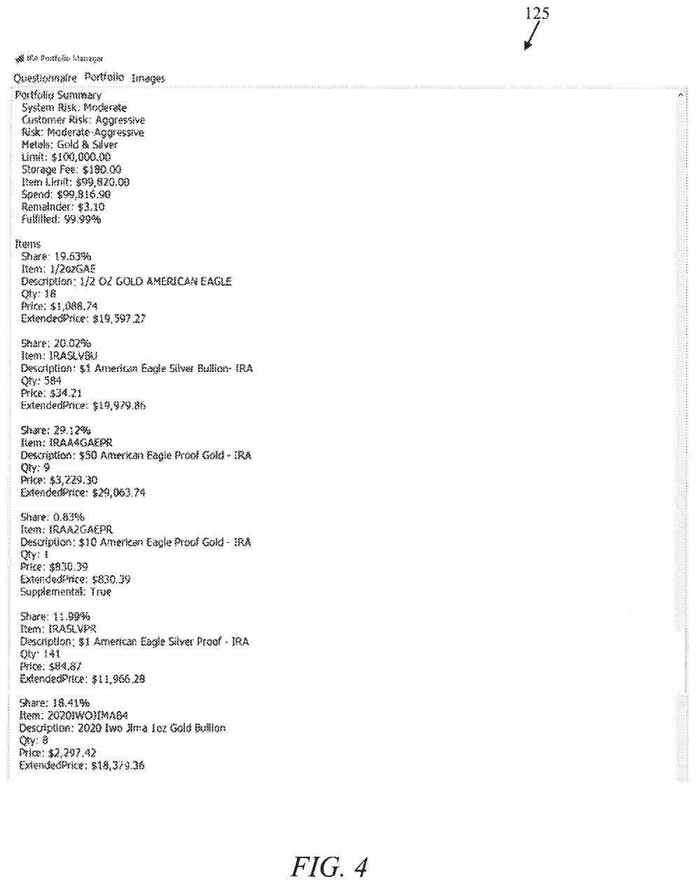

FIG. 4 is an example of display of a precious metal portfolio information set 125 generated by the system and method herein. A Portfolio Summary section presents fields including the System Risk, Customer Risk, the combined Risk, the metals selection, the client gross spend amount (Limit), the Storage Fees, the client net spend amount (Spend) which is the investment amount of precious metal items, the remainder (cash holding) and the percent fulfillment. A detailed Items section presents fields for each of the allocated items, including the share percentage, the item code, the item description, the quantity, the item price, and the extended price.

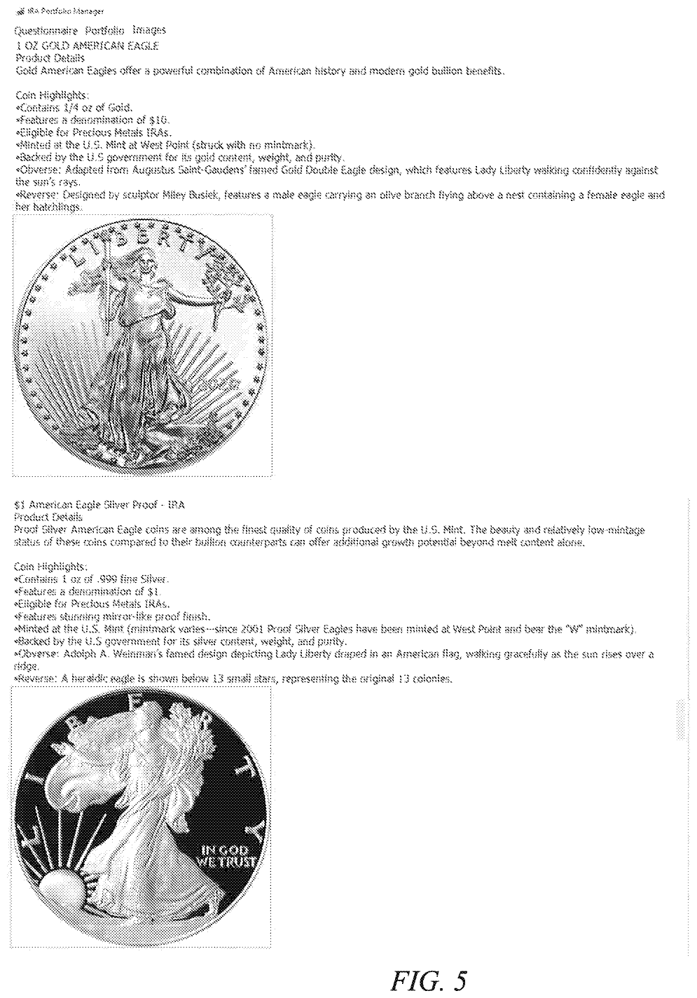

FIG. 5 is an example of certain product details for precious metal items that can be provided in the method and system. The details include: name; product details; item highlights including precious metal type and content, form (that is, coin, bar, bullion), denomination, IRA eligibility, mint location, government backing information, description of the obverse image, and description of reverse image; and an image (obverse image shown, but the reverse can also be shown).

The precious metal portfolio information set 125 comprises a list and quantity of each precious metal item in the portfolio. Additionally, the percentage of the portfolio for each precious metal item, the precious metal item description, the price per precious metal item, and/or total value of each precious metal item can be provided.

### Precious Metal Item Inventory/Information Table

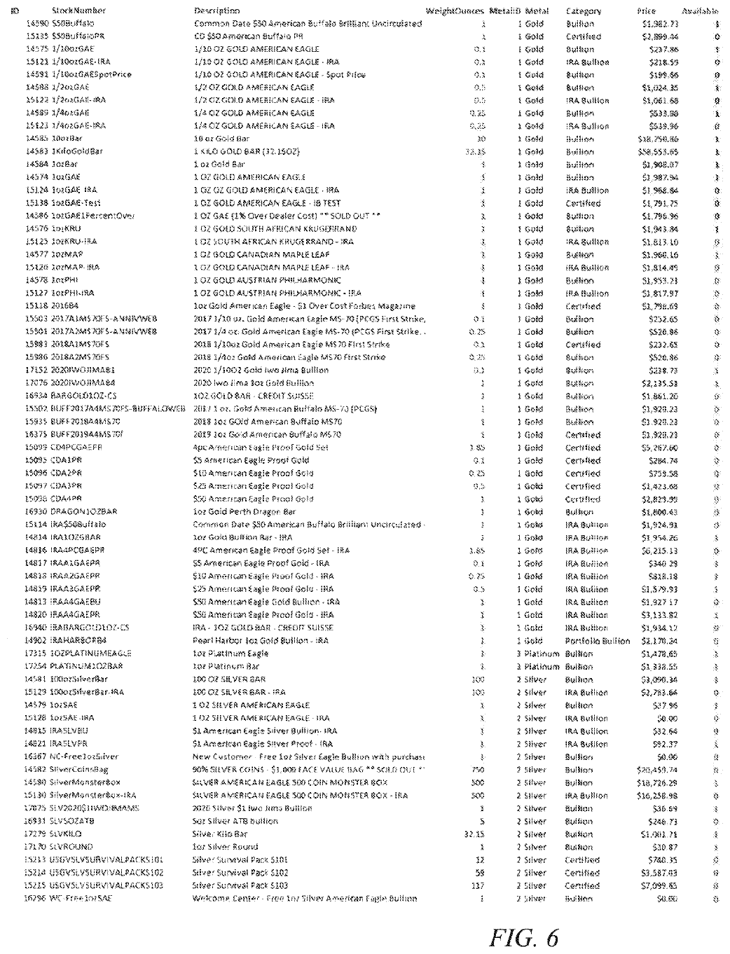

The precious metal item module 140 includes a precious metal item inventory/information table of precious metal items. The value of the precious metal items for use precious metal portfolio information set 125 is based on the data in the precious metal item inventory/information table. FIG. 6 is an example of a precious metal item inventory/information table of precious metal items, including as main fields: one or more item identifiers shown as item ID and stock number, item description, item weight, metal type (which can be text and or encoded), category (for instance, bullion coin, certified coin, IRA bullion coin, portfolio bullion, bar), item price/value in currency units, and number of items available. In certain embodiments the precious metal item table includes a listing of precious metal items that qualify under 26 USC 408 which are, for example, one-ounce, one-half ounce, one-quarter ounce, or one-tenth ounce U.S. Treasury gold coins, one-ounce U.S. Treasury silver coins minted, certain platinum coins and certain gold, silver, palladium, and platinum bullion, for example designated in FIG. 6 as IRA bullion. The item identifiers in the precious metal item inventory/information table correlate with item identifiers in the precious metal item percent table.

The precious metal items in the precious metal item table can change in value differently. Precious metal items suitable for IRA accounts include bullion coins and also numismatic coins that are permissible under the Internal Revenue Code such as gold and silver US Proof Coins. Certain precious metal items appreciate based on spot price of the underlying precious metal, which can be referred to as “base” metal items for a portfolio, such as bullion coins. Other precious metal items can appreciate or depreciate based on spot price of the underlying precious metal, and also based on unique markup, referred to as enhanced precious metal items. For investors willing to accept higher risk, enhanced precious metal items are added to the portfolio, typically along with other base precious metal items. The entire price of the precious metal item is considered a qualified IRA investment. Every IRA qualified coin has a unique markup; traditionally, this markup is not considered numismatic value, which in contrast is primarily associated with certified items such as graded coins. The liquidity of enhanced precious metal items can be different as compared to the base precious metal items.

### Precious Metal Item Percent Table

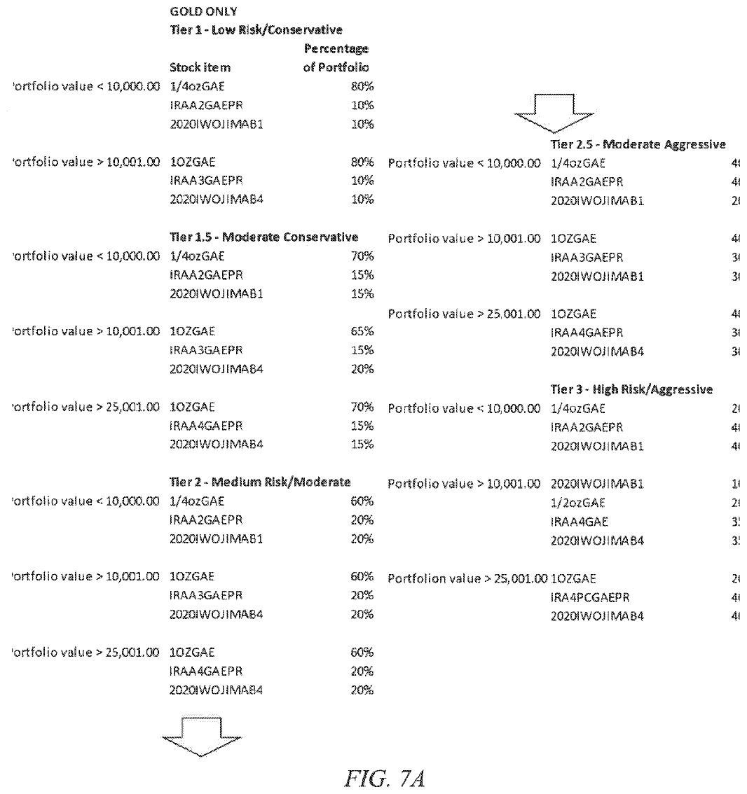

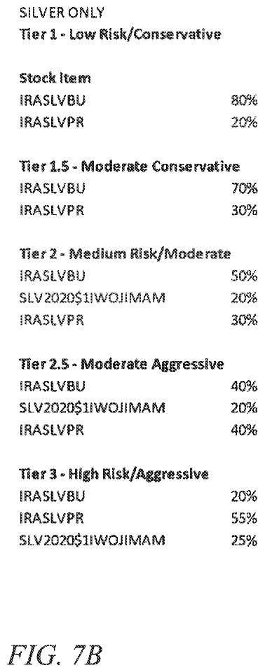

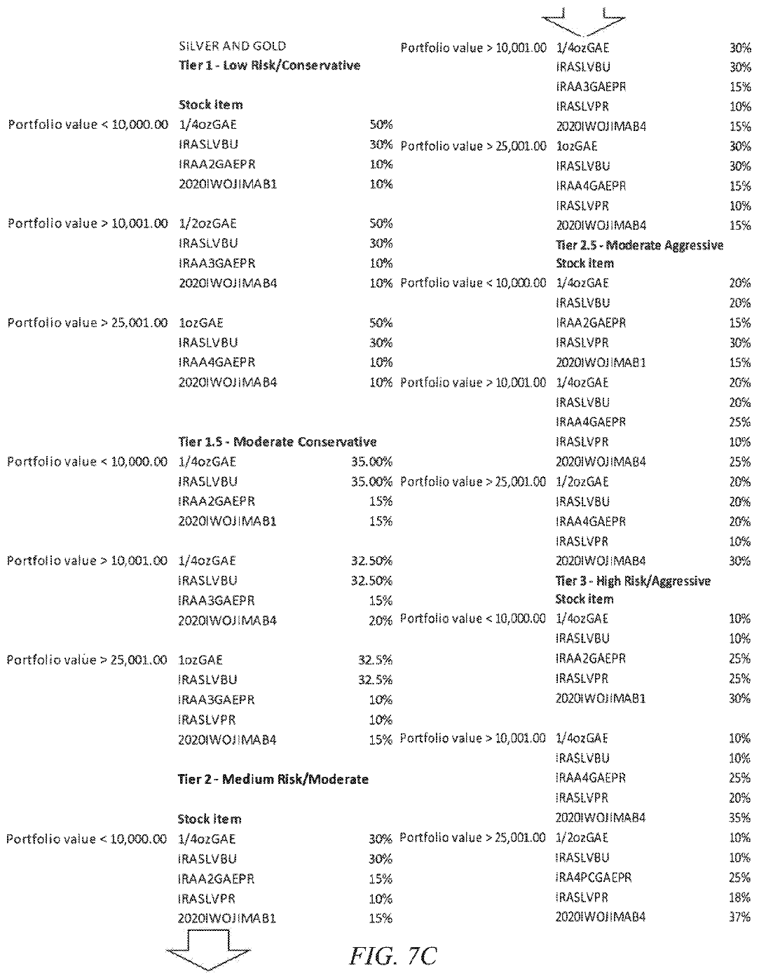

In addition, the precious metal item percent table is provided the precious metal item percent module 140, or as a part thereof. An example is shown in FIGS. 7A, 7B and 7C. The precious metal item percent table as shown in the example is organized by metal type (gold only (FIG. 7A), silver only (FIG. 7B), or gold and silver (FIG. 7C)). The common identifier for the precious metal item used by the instructions contained in the automated process flow modules and steps are, for example, the “stock item” in the precious metal item percent table of FIGS. 7A, 7B and 7C, which corresponds to the “stock number” in the precious metal item inventory/information table of FIG. 6.

With each metal type, the selections are organized by the risk tier. Within each risk tier, the selections are organized by portfolio value in ranges of in currency units. The risk tiers used in the example are based on the combined risk: Note that in the examples, for the metal selection of silver only, portfolio value is not a factor, generally due to the lower prices of the individual precious metal items, and hence the similarities in the item selection regardless of the portfolio value. This is in contrast to portfolios including gold as there are items that are included in the precious metal item percent table only for portfolios of certain values due to the higher prices of the individual precious metal items (for example, one may not desire to include an individual precious metal item having values of $5000 in a portfolio that is less than $10000).

The precious metal item table generally can include descriptive information about the precious metal item, images (obverse and reverse sides), and updated pricing information for each precious metal item. The updated pricing information is provided by a pre-existing service and/or by a numismatist or other suitable expert.

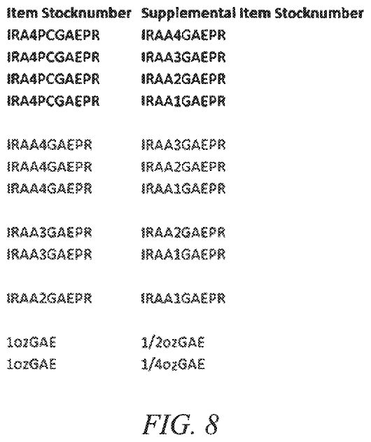

When choosing a precious metal item, if the dollar value has maxed out the dollar value of a particular denomination of the precious metal item, and there are funds remaining to allocate, one can drop down to the denomination of the precious metal item, if applicable. These are described herein as supplemental items. An example of a supplemental item table is provided in FIG. 8. This table shows one or more supplemental items, for instance by supplemental item stock number, that correspond to the primary item stock numbers.

As an example, when building a silver and gold high risk $30K portfolio, the portfolio picker herein allocates 60% of $30K to IRA4PCGAEPR, =$18,000.00 of IRA4PCGAEPR. At a price of $5428.53 per item, that is 3 items, $16,285.59. Then the portfolio picker drops to the next smaller size denomination to fill as much of the remainder as possible. In the example, the amount of $1,714.41 is too small for IRAA4GAEPR, so the portfolio picker back fills with IRAA3PR. If funds are left from that, the portfolio picker drops to IRAA2PR, if funds are left from that the portfolio picker drops to IRAA1PR, until as little cash as possible is remaining.

### EXAMPLE

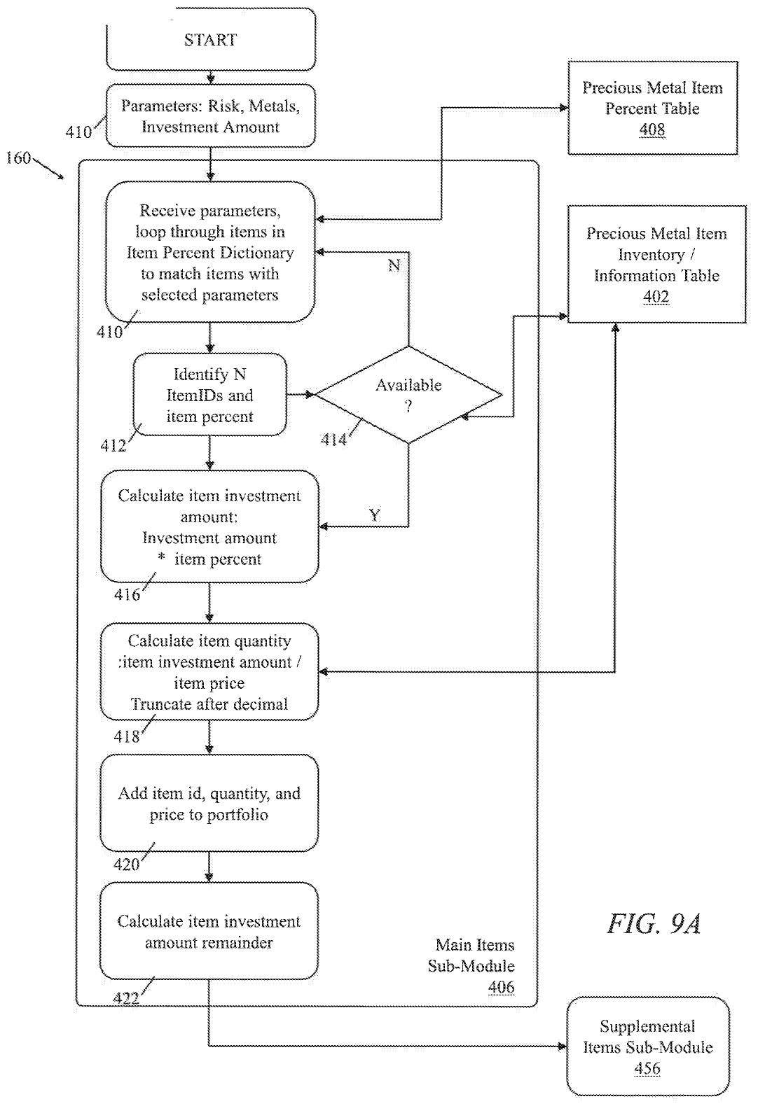

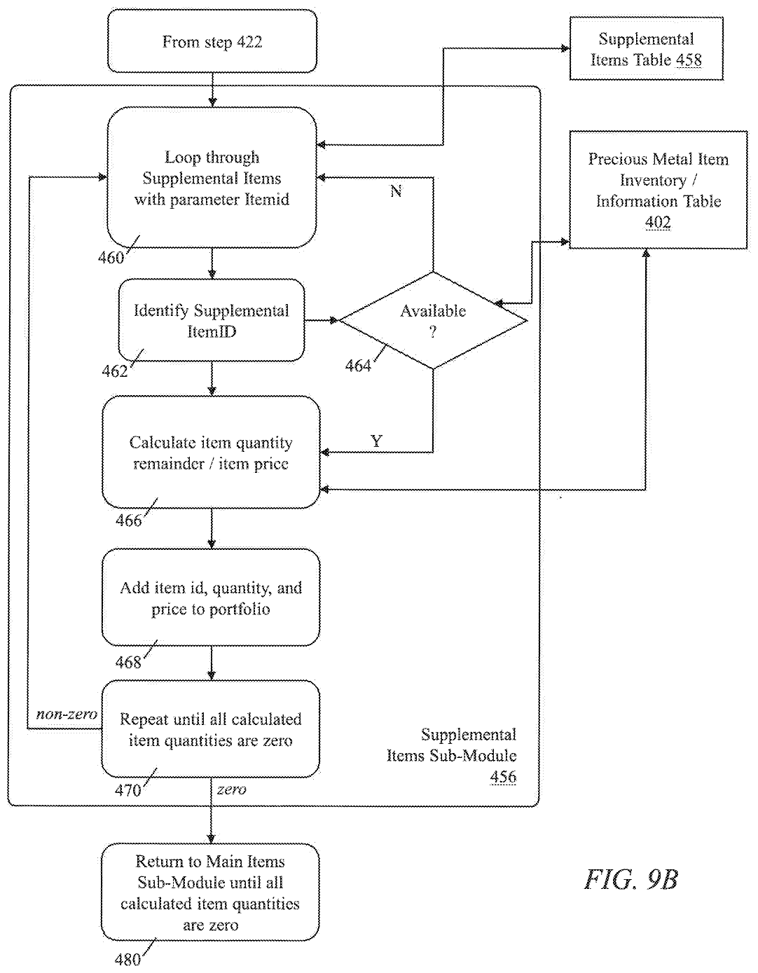

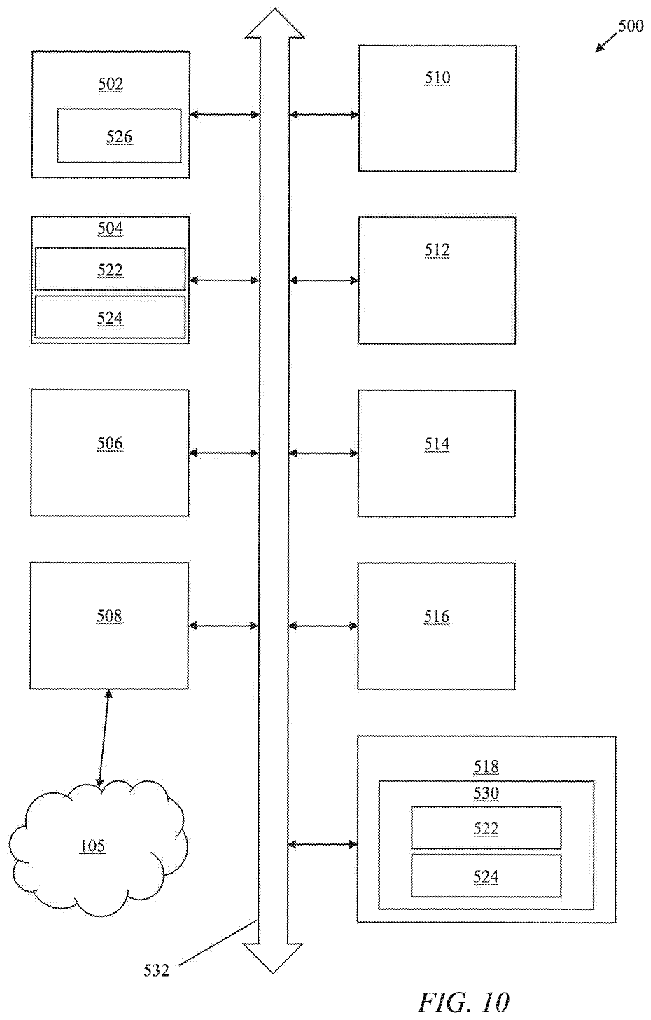

Referring to FIGS. 9A and 9B an example of a precious metal portfolio generation module 160 is provided to enable the portfolio-generating entity to provide the precious metal portfolio information set 125, including main precious metal items and supplemental precious metal items, for example as described herein with respect to step 250 above. The module 160 generally includes a main items sub-module 406 for identifying precious metal items from a precious metal item percent table 408 and quantities thereof, and a supplemental items sub-module 456 for identifying precious metal items from a supplemental items table 458 and quantities thereof. A precious metal item inventory/information table 402 is associated with steps in both sub-modules 406 and 456. The precious metal item inventory/information table 402 contains at least a list of items, prices and indication of availability, for example as show in FIG. 6 herein.

The parameters of the combined risk tolerance, the asset type selection and the investment amount are loaded at step 404. In the main items sub-module 406, at step 410, the parameters are received, and are looped through items in the precious metal item percent table 408 to match precious metal items and percentages that correlate with the selected parameters. At step 412, a quantity of N precious metal items are identified, ItemID-1, ItemID-2 . . . ItemID-N, wherein N is typically 2-5. These represent the main precious metal items that are used to fill each of the percentages of the investment amount, with remaining funds within each percentage of the investment amount spent on supplemental items as identified by type and quantity in the supplemental loop 456. At step 414, availability of selected items is determined with reference to the precious metal item inventory/information table 402. If there is no availability, the process flow returns to step 410 to look through the precious metal item percent table to match other items with the selected parameters, and/or to identify one or more alternative items.

If there is availability, the process flow continues to step 416 where the item investment amount is calculated by multiplying the investment amount by the item percent as obtained from the precious metal item percent table 408. Next, at step 418 the item quantity is obtained, that is, the number of individual units of the selected precious metal item ItemID-1 (and in sequential loops ItemID-2 . . . ItemID-N), by dividing the item investment amount obtained in step 416 by the item price, wherein the item price is obtained from the precious metal item inventory/information table 402, where the value is converted to an integer by a floor function or by truncating after the decimal. At step 420, the selected precious metal itern ItemID value and the total number of that selected precious metal item are added to the precious metal portfolio information set 125.

The final step 422 in the main items sub-module 406 is the calculation of the remainder of funds for the allocated precious metal item. The total value of the items determined in step 418 is subtracted from the item investment amount. This remaining amount is allocated to supplemental items in the module 456 (FIG. 9B).

The supplemental items sub-module 456 process flow commences at step 460 with looping through supplemental items with the parameter itemID that was used to generate the remainder in step 422. At step 462 the supplemental item is identified, and its availability determined at step 464. Availability is determined by lookup in the precious metal item inventory/information table 402. If the item available flag is true then continue, otherwise return to step 460. If the process continues the item quantity is calculated at step 466, by dividing the remainder from 422 by the item price, wherein the item price is obtained from the precious metal item inventory/information table 402, where the value is converted to an integer by a floor function or by truncating after the decimal. At step 468, the selected precious metal item ItemID value and the total number of that selected precious metal item are added to the precious metal portfolio information set 125. The process flow returns to step 460 and the supplemental item loop is repeated until all calculated item quantities are zero. At step 480 the process flow returns to the main items sub-module 406 until all calculated item quantities are zero.

In an example, the parameters are obtained 404, for example, moderate risk, gold only metals, and a $50,000 investment amount. These parameters are loaded at step 410 and it is determined that the allocation is ItemID-1-60%, ItemID-2-20%, and ItemID-3-20%. The item investment amount at step 416 is determined, $50,000×60%=$30,000. From the precious metal item inventory/information table the value of ItemID-1 is determined as $8000. The item quantity at step 418 is calculated as $30,000/$8,000=3.75, truncated to 3. At step 420, the item id, quantity, and price are added to portfolio: ItemID=ItemID-1, Quantity=3, Price=$24,000. The item investment amount remainder is calculated at step 422, $30,000-$24,000=$6,000. In the supplemental items sub-module, a lookup function is called to loop through the supplemental items table 458 containing supplemental items with the parameter ItemID-1. At step 460 supplemental items are identified, for example ItemID-3. The item is looked up in the precious metal item inventory/information table to obtain the price and availability flag, for example ($2,000, true). The item quantity is calculated as $6,000/$2,000=3. The ItemID, quantity, and price are added to the portfolio (ItemID=ItemID-3, Quantity=3, Price=$6,000). Since the remainder of the remainder is zero, the process flow continues to the main item loop until all calculated item quantities are zero.

The price at the time of generation of the portfolio, for instance, when the client intake is completed, is the current price based on a designated standard. The final prices are the item prices at the time of actual fulfillment of the order. In situations in which the client has previously transferred funds, the time of fulfillment of the order can be when the portfolio picker has generated the portfolio items and percentage lists, and the prices are unchanged. In situations in which the client transfers funds after the portfolio items and percentage lists are generated, the time of fulfillment is when the fund transfer from the client has been received, or some other time, the prices change, and the precious metal portfolio information set 125 is updated.

In certain embodiments, the automated process flow modules and steps contain instructions to recalculate and revise the list based on pricing at the time and date of the closing of a financial transaction. The timing of the transaction closing can be when the funds are received, or at the time of the order if the client has pre-deposited funds or has other arrangements. At the closing, the automated process flow modules and steps contain instructions to produce the precious metal portfolio information set 125, which is conveyed to the client or other interested parties via a user display, a physical medium such as printed or braille, audible output or other suitable format, and contains at least the inventory for the various types and denominations of precious metal items. The physical precious metal items in certain accounted, for instance for IRAs, must be maintained by a trustee as defined in Internal Revenue Code § 408(a) as a bank (as defined § 408(n)) or such other person who demonstrates to the satisfaction of the Secretary that the manner in which such other person will administer the trust will be consistent with the requirements of this section (§ 408). This is referred to as a depository account. In certain embodiments, all or a portion of the steps necessary for the creation of a depository account are undertaken based on instructions contained in the automated process flow modules and steps. Further, there exist for certain accounts such as IRAs reporting requirements with the Internal Revenue Service. In certain embodiments, all or a portion of the steps necessary for the reporting of necessary account information is undertaken based on instructions contained in the automated process flow modules and steps.

### Exemplary Technical Platforms

As will be appreciated by one skilled in the relevant field, the present invention may be, for example, embodied as a computer system, a method, or a computer program product, including the computing device 110, the client information module 130, the precious metal item module 140, the precious metal item percent module 150 and the precious metal portfolio generation module 160. As noted above, the modules can reside in the computing device 110 or one or more separate computing devices such as server computers. Embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (for example, software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (for example, systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general-purpose computer, special purpose computer, or other programmable data processing apparatus to produce a machine, such that the instructions which execute on the computer or other programmable data processing apparatus to create means for implementing the functions specified in the flowchart block or blocks.

The program code may include processor-specific instructions generated by a compiler or an interpreter from code written in any suitable computer-programming language, including, for example, C, C++, C#, PHP, Swift, Go, Ruby, Python, JavaScript and SQL. The user interfaces can be in HTML, CSS, JavaScript, Windows Forms, WPF, UWP, Xamarin, iOS, and Android.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

FIG. 9 illustrates a diagrammatic representation of a computer 500 that can be used as a computing device 110 and/or as a server computer. In certain embodiments the computer 500 is the computing device 110 that carries out the steps required for generation of the portfolio picker precious metal portfolio information set 125 described herein.

In particular embodiments, the computer 500 may be connected (for example, networked) to other computers in a LAN, an intranet, an extranet, and/or the Internet. As noted above, the computer 500 may operate in the capacity of a server or a client computer in a client-server network environment, or as a peer computer in a peer-to-peer (or distributed) network environment. The computer 500 may be a personal computer (PC), a tablet PC, a set-top box, a personal digital assistant, a cellular or satellite telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 500 includes a processing device 502, a main memory 504 (for example, read-only memory (ROM), flash memory, dynamic random-access memory (DRAM) such as synchronous DRAM (SDRAM) or Rambus DRAM (RDRAM), etc.), static memory 506 (for example, flash memory, static random-access memory (SRAM), etc.), and a data storage device 518, which communicate with each other via a bus 532.

The processing device 502 represents one or more general-purpose processing devices such as a microprocessor, a central processing unit, or the like. More particularly, the processing device 502 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 may be configured to execute processing logic 526 for performing various operations and steps discussed herein.

The computer 500 may further include a network interface device 508. The computer 500 also may include a video display unit 510 (for example, projection, LCD, LED, OLED, CRT), an alphanumeric input device 512 (for example, a keyboard or tablet), a cursor control device 514 (for example, a mouse or tablet), and a signal generation device 516 (for example, a speaker).

The data storage device 518 may include a non-transitory computer-accessible storage medium 530 (also known as a non-transitory computer-readable storage medium or a non-transitory computer-readable medium) on which is stored one or more sets of instructions (for example, software instructions 522 and data 524) embodying any one or more of the modules, methodologies or functions described herein. All or a portion of the software instructions 522 and/or the data 524 may also reside, completely or at least partially, within main memory 504 and/or within processing device 502 during execution thereof by computer 500, wherein main memory 504 and processing device 502 also constituting computer-accessible storage media. The software instructions 522 may further be transmitted or received over a network 105 via network interface device 508.

While the computer-accessible storage medium 530 is shown in an exemplary embodiment to be a single medium, the term “computer-accessible storage medium” should be understood to include a single medium or multiple media (for example, a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

The system and method of the present invention have been described above and with reference to the attached figure; however, modifications will be apparent to those of ordinary skill in the art and the scope of protection for the invention is to be defined by the claims that follow.

1-3. (canceled)

4. An automated numismatist system comprising:
a processor;
a memory coupled to the processor, wherein the memory is configured to store program instructions executable by the processor;
wherein in response to executing the program instructions, the processor is configured for:
receiving, by a processor, data associated with a plurality of metals;
receiving, by the processor, user information;
calculating, by the processor, an indicator based on the user information; and
determining, by the processor, a set of optimal metals from the plurality of metals based on the indicator and data.
